(19) United States
(12) Patent Application Publication
(10) Pub. No.: US 2021/0230082 A1
(43) Pub. Date: Jul. 29, 2021

(54) PLANT NUTRIENT COMPOSITIONS

(71) Applicant: Nutrifield Pty Ltd, Sunshine West, Victoria (AU)

(72) Inventors: Jamie SELBY-PHAM, Sunshine West (AU); Kimber WISE, Sunshine West (AU)

(21) Appl. No.: 17/255,229

(22) PCT Filed: Jun. 14, 2019
(86) PCT No.: PCT/AU2019/050614

§ 371 Date: Dec. 22, 2020

(30) Foreign Application Priority Data
Jun. 26, 2018 (AU) 2018902289

(51) Int. Cl. C05G 1/00; C05D 7/00; C05G 3/40; C05G 3/60; C05G 5/14; C05G 5/23

(52) U.S. Cl. CPC C05G 1/00; C05D 7/00; C05G 5/23; C05G 3/60; C05G 5/14; C05G 3/44

(57) ABSTRACT

The present disclosure generally relates to solution dispersible plant nutrient compositions, and methods of preparing and use thereof. The solution dispersible plant nutrient composition can provide a plant nutrient with a source of nitrogen, phosphorus and potassium and where the composition comprises an amount of polyethylene glycol for facilitating dispersion and dissolution of the plant nutrient source into an aqueous solution.

### FIELD

The present disclosure generally relates to solution dispersible plant nutrient compositions, and methods of preparing and use thereof.

### BACKGROUND

Plant nutrient compositions are one of the most important determining factors of plant growth and quality. There are at least 14 elements known to be essential or key nutrients for plants. Generally, the soil in which a plant grows delivers key nutrients such as nitrogen, phosphorus, potassium, calcium, magnesium, and sulfur. These key nutrients are also referred to as macronutrients. Soil also delivers plants with trace amounts of nutrients such as iron, manganese, boron, molybdenum, copper, zinc, and cobalt. These nutrients are the so-called micronutrients. It is important for the macro- and micronutrients to be available in sufficient amounts and appropriate ratios in order to promote plant growth, development and quality. In hydroponic systems, plants grow using plant nutrient compositions in the form of a solution without soil and as such the plant nutrient composition must provide the plant with the essential nutrients.

Typically, plant nutrient compositions are provided in either 1-part, 2-part or 3-part liquid concentrates. Most 2- and 3-part liquid concentrates provide adequate levels of macro- and micronutrients for plant growth and development. The packaging format of the 2- or 3-part plant nutrients avoids solubility/stability/compatibility problems between certain nutrient species when present in the same bottle. However, this packaging format creates additional problems such as weight for transport and dilution/dosage errors. It is well-known that 1-part liquid concentrates are desirable for ease-of-use, however, it is known that 1-part liquid concentrates generally contain large amounts of sedimentation as a result of precipitation. Furthermore, these liquid concentrates are typically deficient in some essential nutrients, such as sulfate, in order to avoid precipitation problems and loss of nutrient. It is common for 1-part liquid concentrates to utilize “slurry” technology to provide a highly concentrated mixture of macronutrients. The “slurry” is a soluble suspension of mainly calcium sulfate (CaSO₄) within a solution containing the balance of essential macro- and micronutrients. The user is required to shake the “slurry” prior to use to avoid loss of adequate levels of essential nutrients. It is also common for plant nutrient compositions to be supplied in 2-part powders. If powder compositions are used, the user must mix the two powders separately and then add them together as a solution. The reason being that the calcium nitrate is poorly soluble and dissolves better when mixed individually. Powdered fertilizers are more complicated to use than liquid solutions due to the premixing of the powders leading to human error in dosage. More recently, 1-part powders are available which avoid the need to mix dissolved powdered solutions to form a complete nutrient solution, however problems arise with precipitation and loss of nutrient.

Electrical conductivity (EC) and pH regulation are important measurements. A measure of the EC provides an indication of the concentration of nutrients present in the plant nutrient solution. The higher the concentration, the higher the level of EC, hence EC can be used as an indicator of the nutrient strength of a solution. It is important to know the EC of the plant nutrient solution as the EC level provides an indication of the strength of the solution such that the nutrient level can be controlled and plant growth sustained. The pH is a parameter that measures the acidity or alkalinity of the plant nutrient solution where the pH value indicates the availability of nutrients to plants. For most commonly grown hydroponic crops, an optimal pH range is between 5.5 and 6.5. Commercial growers often use a narrower range of 5.8 to 6 for most crops when they are using automatic controllers that regularly dose acid into recirculating systems to maintain this precise level. The optimal acidic pH range for hydroponic crops is important as it affects the solubility, availability and uptake of several of the essential plant nutrients. If the pH drifts, some essential nutrients will form insoluble salts that precipitate out of the nutrient solution, meaning the uptake of essential nutrients by the plant or crop becomes inefficient and leads to plant nutrient deficiencies. In the case of hydroponic systems, pH regulation is typically tested daily and adjusted using specifically designed pH up and down products that are typically concentrated solutions of, for example, approx. 60% phosphoric acid or approx. 40% potassium hydroxide solutions.

There is a need to provide a plant nutrient composition that can dissolve quickly to provide a nutrient rich aqueous solution with suitable electron conductivity and pH. There is also a need to provide a plant nutrient composition that achieves fast dissolution and dispersion of the plant nutrient composition in an aqueous solution that can reduce or prevent precipitation of essential nutrients.

### SUMMARY

The present disclosure relates to a solution dispersible plant nutrient composition comprising a plant nutrient source and a polyethylene glycol filler. The plant nutrient composition can be used for hydroponic use, for example using a solution dispersible plant nutrient solution to deliver the necessary nutrients that plants need for development without the use of soil. The plant nutrient composition can be used for industrial agriculture, for example using a solution dispersible plant nutrient solution to deliver the necessary nutrients to large scale crops grown in soil.

In one aspect, there is provided a solution dispersible plant nutrient composition comprising: a plant nutrient source comprising nitrogen, phosphorus and potassium, for providing nutrients to a plant; and a polyethylene glycol filler in an amount of about 6% w/w to about 30% w/w for facilitating dispersion and dissolution of the plant nutrient source into an aqueous solution. The solution dispersible plant nutrient composition may comprise a plant nutrient source comprising nitrogen, phosphorus and potassium, for providing nutrients to a plant; a polyethylene glycol filler in an amount of about 6% w/w to about 30% w/w for facilitating dispersion and dissolution of the plant nutrient source into an aqueous solution; and an effervescent agent. The polyethylene glycol may be selected from the group consisting of polyethylene glycol 200, polyethylene glycol 300, polyethylene glycol 400, polyethylene glycol 540, polyethylene glycol 600, polyethylene glycol 1000, polyethylene glycol 1450, polyethylene glycol 3350, polyethylene glycol 4000, polyethylene glycol 4600, polyethylene glycol 8000, and combinations thereof. In an example, the polyethylene glycol is polyethylene glycol 3350.

It is understood that the plant nutrient source in the plant nutrient composition comprises macronutrients and micronutrients. The plant nutrient source may comprise macronutrients selected from at least one of nitrogen, phosphorus and potassium. In an example, the content of nitrogen is present in an amount of about 0% to about 10% nitrogen, the content of phosphorous is present in an amount of about 0% to about 10%, and the content of potassium is present in an amount of about 0% to about 10%. The plant nutrient source may comprise micronutrients selected from at least one of iron, zinc, manganese, calcium and magnesium. In an example, the plant nutrient source comprises chelated micronutrients. Several chelating agents may be used to form the chelated micronutrients. The chelating agents may be selected from the group consisting of organic acids and inorganic acids. The organic acids may be selected from the group consisting of ammonium and metal salts of hydroxy acids, glucamines, ethylenediaminetetraacetic acid (EDTA), hydroxyl ethylenediaminetetraacetic acid (HEDTA), diethylenetriaminepentaacetic acid (DTPA), ethylenediamine-N,N′-bis(2-hydroxyphenylacetic acid) (EDDHA), nitrilotriacetic acid (NTA), and combinations thereof. For example the chelating agent may be formic acid, acetic acid, propionic acid, butyric acid, valeric acid, caproic acid, oxalic acid, lactic acid, malic acid, citric acid, benzoic acid, carbonic acid, phenol, uric acid, taurine, triflic acid, fulvic acid, humic acid, EDTA, HEDTA, DTPA, EDDHA, NTA, hydrochloric acid, nitric acid, sulfuric acid, hydrofluoric acid, perchloric acid, or any combinations thereof. The inorganic acid may be boric acid.

The plant nutrient composition may comprise an effervescent agent. The effervescent agent may comprise a carbon dioxide agent, and optionally an acid agent. In an example the plant nutrient composition comprising the carbon dioxide agent may be added to an acidified solution. The carbon dioxide agent may comprise potassium carbonate, potassium bicarbonate, sodium carbonate, sodium bicarbonate, calcium carbonate, calcium bicarbonate, iron carbonate, ammonium carbonate, ammonium bicarbonate, lithium carbonate, magnesium carbonate, magnesium bicarbonate, or any combinations thereof. In an example, the carbon dioxide agent is selected from at least one of potassium carbonate and potassium bicarbonate. The acid agent may be an organic acid, an inorganic acid, or any combination thereof. For example the acid agent may comprise formic acid, acetic acid, propionic acid, butyric acid, valeric acid, caproic acid, oxalic acid, lactic acid, malic acid, citric acid, benzoic acid, carbonic acid, uric acid, fulvic acid, humic acid, EDTA, HEDTA, DTPA, EDDHA, NTA, hydrochloric acid, nitric acid, sulfuric acid, boric acid, hydrofluoric acid, perchloric acid or any combinations thereof. In an example, the acid agent is citric acid. In another example, the acid agent may be citric acid in combination with one or more acid agents described herein.

In a second aspect, there is provided a tablet containing the plant nutrient composition described herein. In an embodiment, the tablet may comprise the plant nutrient source, the polyethylene glycol filler, optionally the acid agent, the carbon dioxide agent, optionally an antifoaming agent, and optionally an antimicrobial agent. In an example, the tablet consists of between about 20% to about 50% w/w of the plant nutrient source, between about 6% to about 20% w/w of the polyethylene glycol filler, between about 20% to about 35% w/w of the acid agent, between about 25% to about 35% w/w of the carbon dioxide agent, between about 0.1% to about 2.0% w/w of the antifoaming agent, and between about 0.05% to about 0.5 w/w of the antimicrobial agent.

In an third aspect, there is provided a powder containing the plant nutrient composition described herein. In an embodiment, the powder may comprise the plant nutrient source, the polyethylene glycol filler, optionally an antifoaming agent, and optionally an antimicrobial agent. In an example, the powder consists of between about 65% to about 90% w/w of the plant nutrient source, between about 10% to about 30% w/w of the polyethylene glycol filler, between about 0.1% to about 2.0% w/w of the antifoaming agent, and between about 0.05% to about 0.5 w/w of the antimicrobial agent.

In a fourth aspect, there is provided a method of preparing a plant nutrient solution by introducing a plant nutrient composition described above in an aqueous solution. The plant nutrient composition may be introduced into the aqueous solution as a single dose to provide one or more nutrients, base nutrients, nutrient supplements, or any combination thereof to the plant for a predetermined time. In an example, the predetermined time is about 1 day, 1 week, 2 weeks, 1 month, 2 months or every three months. When the plant nutrient composition is provided in the form of a powder, the powder may be introduced with further agitation of the aqueous solution. When the plant nutrient composition is provided in the form of a tablet, the tablet may be introduced without any agitation of the aqueous solution.

### DETAILED DESCRIPTION

The present disclosure describes the following various non-limiting examples, which relate to investigations undertaken to identify new plant nutrient compositions for plants and crops grown hydroponically and/or in soil. It was surprisingly found that a solution dispersible plant nutrient composition comprising a plant nutrient source and a polyethylene glycol filler advantageously provides a plant nutrient composition that rapidly dissolves and disperses in an aqueous solution such that the rapid dissolution and dispersion reduces or prevents the formation of highly concentrated pockets of the plant nutrient source and associated precipitation and loss of nutrients. In one embodiment, the plant nutrient composition is a solution dispersible plant nutrient composition comprising the plant nutrient source and the polyethylene glycol filler in an amount of about 6% w/w to about 30% w/w. One advantage of the solution dispersible plant nutrient composition comprising the plant nutrient source and the polyethylene glycol filler in an amount of about 6% w/w to about 30% w/w of the present disclosure, at least according to some embodiments or examples as described herein, is that the composition can facilitate dispersion and dissolution of the plant nutrient source into an aqueous solution. In another embodiment, the plant nutrient composition is a tablet composition comprising the plant nutrient source, the polyethylene glycol filler, an acid agent, and a carbon dioxide agent of the present disclosure. One advantage of the tablet composition containing the plant nutrient source, the polyethylene glycol filler, the acid agent, and the carbon dioxide agent of the present disclosure, at least according to some embodiments or examples as described herein, is that the tablet composition works together to achieve fast dissolution and dispersion of the plant nutrient source in an aqueous medium such that this fast dissolution and dispersion prevents the formation of highly concentrated pockets of the plant nutrient source, thereby reducing or preventing problems known in the art, including precipitation of essential nutrients resulting in the loss of their availability thereof to the plant or crop.

### General Definitions and Terms

Unless specifically defined otherwise, all technical and scientific terms used herein shall be taken to have the same meaning as commonly understood by one of ordinary skill in the art (e.g., in nutrient solutions, hydroponics, fertilisers, and the like).

The term “and/or”, e.g., “X and/or Y” is be understood to mean either “X and Y” or “X or Y” and provides explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

As used in this specification and the appended claims, terms in the singular and the singular forms “a,” “an” and “the”, for example, optionally include plural referents unless the content clearly dictates otherwise. Thus, for example, reference to “a macronutrient” optionally includes more than one macronutrient.

As used herein, the term “about”, unless stated to the contrary, refers to +/−10%, more preferably +/−5%, more preferably +/−1%, of the designated value.

As used herein, the term “plant nutrient source” refers to any composition suitable for plant growth. For example, a plant nutrient source can include a macronutrient and micronutrient for which a plant must be able to obtain from their growing medium. A macronutrient can be any one or more of nitrogen (N), phosphorus (P), potassium (K), calcium (Ca), sulfur (S), magnesium (Mg), carbon (C), oxygen (0), hydrogen (H). A micronutrient can be any one or more of iron (Fe), boron (B), chlorine (Cl), manganese (Mn), zinc (Zn), copper (Cu), molybdenum (Mo), nickel (Ni). The macro- and micronutrients must be available in sufficient amounts and appropriate ratios. The plant nutrient source can include one or more nutrients as described herein. The plant nutrient source can include base nutrients. The plant nutrient source can include a nutrient supplements.

As used herein, the term “filler” refers to an agent that is typically added to a composition to make the required bulk. In a typical tablet composition, a filler is included in addition to an active agent, binder, lubricant, etc. In an example, a filler can include a physiologically inert, non-toxic, physically and chemically stable agent that is free from microbial contamination and does not alter the bioavailability of a nutrient source.

As used herein, the term “hydroponics” refers to a method for growing plants in a water-nutrient solution without the use of nutrient-rich soil. Typically, most soil conditions provide plants with sufficient amounts of macro- and micronutrients, without the addition of a plant nutrient solution, except in circumstances where the soil is cropped, it is necessary to add a plant nutrient solution to promote adequate growth and increased crop yield.

As used herein, the term “nutrient” or “nutrients”

As used herein, the term “fast” refers to the rate at which the plant nutrient source dissolves and disperses in an aqueous solution. The rate of dissolution and dispersion of the plant nutrient source in the plant nutrient composition is such that the dissolution and dispersion of the plant nutrient composition prevents the formation of highly concentrated pockets of the plant nutrient source and thereby avoiding precipitation and loss of essential plant nutrients.

### Abbreviated Terms

PEG—polyethylene glycol,
EDTA—ethylenediaminetetraacetic acid,
HEDTA—hydroxyl ethylenediaminetetraacetic acid,
DTPA—diethylenetriaminepentaacetic acid,
EDDHA—ethylenediamine-N,N′-bis(2-hydroxyphenylacetic acid),
NTA—nitrilotriacetic acid,
EC—electrical conductivity

### Plant Nutrient Compositions

The plant nutrient compositions of the present disclosure comprise a plant nutrient source and a polyethylene glycol filler. The plant nutrient source may comprise a macronutrient and a micronutrient for which a plant must be able to obtain from their growing medium. A macronutrient can be any one or more of nitrogen (N), phosphorus (P), potassium (K), calcium (Ca), sulfur (S), magnesium (Mg), carbon (C). A micronutrient can be any one or more of iron (Fe), boron (B), chlorine (Cl), manganese (Mn), zinc (Zn), copper (Cu), molybdenum (Mo), nickel (Ni). The macro- and micronutrients must be available in sufficient amounts and appropriate ratios. It is believed that at least according to some embodiments, the polyethylene glycol filler advantageously facilitates and improves dispersion and dissolution of the plant nutrient source into an aqueous solution.

### Plant Nutrient Source

It will be appreciated that the macronutrient(s) present in the plant nutrient source can vary depending on the type of plant or crop and stage in the plant life cycle. In some embodiments, the plant nutrient source may comprise macronutrients selected from at least one of nitrogen, phosphorus and potassium, wherein the content of nitrogen may be present in an amount of about 0% to about 10% nitrogen, the content of phosphorous may be present in an amount of about 0% to about 10%, and the content of potassium may be present in an amount of about 0% to about 10%. The content of nitrogen may be present in an amount of about 0.5% to about 3%, the content of phosphorus may be present in an amount of about 0% to about 4%, and the content of potassium may be present in an amount of about 1.5% to about 5.5%. The content of nitrogen present in the plant nutrient source may be less than about 10%, less than about 8%, less than about 6%, or less than about 4%. The content of phosphorus may be less than about 10%, less than about 8%, less than about 6%, or less than about 4%. The content of potassium present in the plant nutrient source may be less than about 10%, less than about 8%, or less than about 6%.

In some embodiments, the plant nutrient source may comprise micronutrients. For example, the macro- and/or micronutrients may be chelated. The micronutrients and/or macronutrients may be in their chelated form prior to their use in the plant nutrient composition. The chelated macro- and/or micronutrients advantageously enables the chelated macro- and /or micronutrient to be better utilized by the plant or crop. In some embodiments, chelated macro- and/or micronutrients provide better solubility when dissolving the solid macro- and/or micronutrients. More macro- and/or micronutrients e.g. Fe may be soluble when compared to a plant nutrient system without any chelating agent of the same aqueous solution pH. This is particularly relevant in plant systems where there is a risk of increasing pH e.g. hydroponics. In an example, chelated micronutrients include Zn, Fe, Ca, Cu, Mg and Mn. The various chelating agents may be selected from the group consisting of ammonium and metal salts of hydroxy acids, glucamines, EDTA, HEDTA, DTPA, EDDHA, NTA, and combinations thereof. The chelating agent may comprise formic acid, acetic acid, propionic acid, butyric acid, valeric acid, caproic acid, oxalic acid, lactic acid, malic acid, citric acid, benzoic acid, carbonic acid, phenol, uric acid, taurine, triflic acid, fulvic acid, humic acid, EDTA, HEDTA, DTPA, EDDHA, NTA, hydrochloric acid, nitric acid, sulfuric acid, boric acid, hydrofluoric acid, perchloric acid, or any combinations thereof. In an example, the chelated micronutrients present in the plant nutrient source may be Fe DTPA, Cu EDTA, Zn EDTA, Mg EDTA, and Fe EDDHA.

The amount of plant nutrient source can vary depending on the desired application of the plant nutrient composition. In some embodiments, the plant nutrient source may be present in the plant nutrient composition in an amount of about 15% w/w to about 95% w/w based on the total weight of the plant nutrient composition, for example, the plant nutrient source may be present in an amount of about 20% w/w to about 90% w/w.

In some embodiments, the plant nutrient source is present in a tablet containing the plant nutrient composition disclosed herein. For example, the plant nutrient source may be present in the tablet in an amount of about 20% w/w to about 50% w/w based on the total weight of the plant nutrient composition. The plant nutrient source may be present in an amount of about 25% w/w to about 45% w/w based on the total weight of the plant nutrient composition. The plant nutrient source may be present in an amount of about 30% w/w to about 40% w/w based on the total weight of the plant nutrient composition. The plant nutrient source may be present in an amount of about 32% w/w to about 38% w/w based on the total weight of the plant nutrient composition. The plant nutrient source may be present in an amount of less than about 50% w/w, less than about 48% w/w, less than about 45% w/w, less that about 42% w/w, less than about 40% w/w, or less than about 38% w/w. The plant nutrient source may be present in an amount of more than about 20% w/w, more than about 22% w/w, more than about 25% w/w, more that about 28% w/w, more than about 30% w/w, or more than about 32% w/w.

In other embodiments, the plant nutrient source may be present in an amount between any two of the previous upper and/or lower ranges as described above.

In some embodiments, the plant nutrient source is present in a powder containing the plant nutrient composition disclosed herein. For example, the plant nutrient source may be present in the powder in an amount of about 65% w/w to about 90% w/w based on the total weight of the plant nutrient composition. The plant nutrient source may be present in an amount of about 68% w/w to about 88% w/w based on the total weight of the plant nutrient composition. The plant nutrient source may be present in an amount of about 70% w/w to about 85% w/w based on the total weight of the plant nutrient composition. The plant nutrient source may be present in an amount of about 72% w/w to about 82% w/w based on the total weight of the plant nutrient composition. The plant nutrient source may be present in an amount of about 74% w/w to about 80% w/w based on the total weight of the plant nutrient composition. The plant nutrient source may be present in an amount of less than about 90% w/w, less than about 88% w/w, less than about 85% w/w, less that about 82% w/w, or less than about 80% w/w. The plant nutrient source may be present in an amount of more than about 65% w/w, more than about 68% w/w, more than about 70% w/w, more that about 72% w/w, or more than about 74% w/w.

In other embodiments, the plant nutrient source may be present in an amount between any two of the previous upper and/or lower ranges as described above.

### Polyethylene Glycol Filler

The polyethylene glycol filler may be present in an amount of about 6% w/w to about 30% w/w based on the total weight of the plant nutrient composition. For example, the amount of polyethylene glycol may be more than about 6% w/w based on the total weight of the plant nutrient composition. In an example, the polyethylene glycol may be present in a powder containing the plant nutrient composition disclosed herein in an amount of about 10% w/w to about 30% w/w based on the total weight of the powder. In an example, the polyethylene glycol may be present in a tablet containing the plant nutrient composition in an amount of about 6% w/w to about 20% w/w based on the total weight of the tablet.

The polyethylene glycol filler may be selected from the group consisting of polyethylene glycol 200, polyethylene glycol 300, polyethylene glycol 400, polyethylene glycol 540, polyethylene glycol 600, polyethylene glycol 1000, polyethylene glycol 1450, polyethylene glycol 3350, polyethylene glycol 4000, polyethylene glycol 4600, polyethylene glycol 8000, and combinations thereof. For example, the polyethylene glycol may be selected from polyethylene glycol 1000, polyethylene glycol 1450, polyethylene glycol 3350, polyethylene glycol 4000, polyethylene glycol 4600, and combinations thereof. In an example, the polyethylene glycol filler may be polyethylene glycol 3350.

The polyethylene glycol filler when present in the plant nutrient composition in an amount of about 6% w/w to about 30% w/w based on the total weight of the plant nutrient composition advantageously facilitates dispersion and dissolution of the plant nutrient source into an aqueous solution.

In some embodiments, the polyethylene glycol filler is present in a tablet containing the plant nutrient composition disclosed herein. For example, the polyethylene glycol filler may be present in the tablet in an amount of about 6% w/w to about 30% w/w based on the total weight of the tablet. The polyethylene glycol filler may be present in an amount of about 6.5% w/w to about 20% w/w based on the total weight of the tablet. The polyethylene glycol filler may be present in an amount of about 7% w/w to about 15% w/w based on the total weight of the tablet. The polyethylene glycol filler may be present in an amount of about 7.5% w/w to about 12% w/w based on the total weight of the tablet. The polyethylene glycol filler may be present in an amount of about 8% w/w to about 10% w/w based on the total weight of the tablet, which can provide further solubility advantages at least according to some embodiments or examples as described herein. The polyethylene glycol filler may be present in an amount of less than about 30% w/w, less than about 28% w/w, less than about 25% w/w, less that about 22% w/w, less than about 20% w/w, less than about 18% w/w, less than about 15% w/w, less that about 12% w/w, or less than about 10% w/w. The polyethylene glycol filler may be present in an amount of more than about 6% w/w, more than about 6.5% w/w, more than about 7% w/w, more that about 7.5% w/w, more than about 8% w/w, or more than about 8.5% w/w.

In other embodiments, the polyethylene glycol filler may be present in an amount between any two of the previous upper and/or lower ranges as described above.

In some embodiments, the polyethylene glycol filler is present in a powder containing the plant nutrient composition disclosed herein. For example, the polyethylene glycol filler may be present in the powder in an amount of about 6% w/w to about 30% w/w based on the total weight of the powder. The polyethylene glycol filler may be present in an amount of about 8% w/w to about 28% w/w based on the total weight of the powder. The polyethylene glycol filler may be present in an amount of about 10% w/w to about 26% w/w based on the total weight of the powder. The polyethylene glycol filler may be present in an amount of about 15% w/w to about 25% w/w based on the total weight of the powder. The polyethylene glycol filler may be present in an amount of about 18% w/w to about 22% w/w based on the total weight of the powder. The polyethylene glycol filler may be present in an amount of less than about 30% w/w, less than about 29% w/w, less than about 28% w/w, less that about 27% w/w, less than about 26% w/w, less than about 15% w/w, less than about 24% w/w, less that about 23% w/w, less than about 22% w/w, or less than about 21% w/w. The polyethylene glycol filler may be present in an amount of more than about 6% w/w, more than about 8% w/w, more than about 10% w/w, more that about 12% w/w, more than about 15% w/w, more than 18%, or more than about 19% w/w.

In other embodiments, the polyethylene glycol filler may be present in an amount between any two of the previous upper and/or lower ranges as described above.

### Optional Additives

In some embodiments or examples, the plant nutrient composition optionally comprises or consists of one of more additives. Suitable additives are known to the person skilled in the art. Examples of such additives include any one or more of:
(i) antifoaming agent including for example Dow Corning GP-7070 powdered antifoam, Xiameter° APW-4503 powdered antifoam, Xiameter° ACP-1920 powdered antifoam, CD-2020 powdered silicone antifoam, RD-20 powder antifoam, FLO-2020 powdered antifoam;
(ii) antimicrobial agent including for example artemisia anua extract, essential oil, silver chloride, potassium sorbate, phloxine b, prodigiosin, violacein, oocydin A, citric acid, benzoic acid, sorbic acid, legulinic acid, boric acid, calcium propionate powder (2598), lavorIn® JP (world technology ingredients), DV™ (world technology ingredients), MARINAL® Protek (world technology ingredients), Mirenat®—D, Mirenat®—NS, Mirenat®—NSM, NATAMYCIN;
(iii) colouring agent including for example phloxine b, prodigiosin, violacein, ponceau red (CAS: 2611-82-7), brown LLB powder colour (CAS: 4553-89-3, 53026-69-9), brilliant blue (CAS: 3844-45-9), brilliant green, chlorophyll, spirulina, pure tintex food grade dye, phylam food grade powdered dyes e.g. annatto powder, chromatech food grade powdered dyes e.g. C71000 Powder/C71003 Granular, Cathay Industries EXACERT food grade water soluble dyes e.g. D&C Red No. 33;
(iv) effervescent agent including for example effervescent agents as described herein;
(v) plant growth regulator;
(vi) biostimulant, including for example, organic and synthetic chelators e.g fulvic acid and humic acid, chitin, chitosan, yeast cell wall, plant stimulants e.g. triacontanol, seaweed extract, molasses, honey, fish emulsions;
(vii) oil e.g essential oil, mineral oil; and/or
(viii) phytohormones

It will be appreciated that all the additives are optional and may be added to further enhance application of the plant nutrient composition or further enhance performance characteristics of the plant nutrient composition. It will be appreciated that more than one type of additive may also be used. Some of the suitable additives as referred to above are described in further detail as follows:

### Antifoaming Agent

In some embodiments, the plant nutrient composition disclosed herein comprise an antifoaming agent. The antifoaming agent may be oil-, water- or silicone-based agents, for example to reduce the formation of foam. In an example, the antifoaming agent is a solid. The antifoaming agent is a powder. In an example the antifoaming agent may be selected from the group consisting of Dow Corning® GP-7070 powdered antifoam, Xiameter® APW-4503 powdered antifoam, Xiameter® ACP-1920 powdered antifoam, CD-2020 powdered silicone antifoam, RD-20 powder antifoam, FLO-2020 powdered antifoam, or any combinations thereof.

In some embodiments, the amount of antifoaming agent present in the plant nutrient composition disclosed herein may be about 0.1% w/w to about 2.0% w/w based on the total weight of the plant nutrient composition. The antifoaming agent may be present in an amount of about 0.2% w/w to about 1.0% w/w of the total weight of the plant nutrient composition. The antifoaming agent may be present in an amount of less than about 2% w/w, less than about 1.8% w/w, less than 1.5% w/w, or less than about 1.3% w/w, less than about 1.0% w/w, or less than about 0.7% w/w based on the total weight of the plant nutrient composition.

In some embodiments, the antifoaming agent is present in a tablet containing the plant nutrient composition disclosed herein. For example, the antifoaming agent may be present in the tablet in an amount of about 0.1% w/w to about 2.0% w/w based on the total weight of the tablet. The antifoaming agent may be present in an amount of about 0.15% w/w to about 1.0% w/w based on the total weight of the tablet. The antifoaming agent may be present in an amount of about 0.18% w/w to about 0.8% w/w based on the total weight of the tablet. The antifoaming agent may be present in an amount of about 0.2% w/w to about 0.6% w/w based on the total weight of the tablet. The antifoaming agent may be present in an amount of about 0.25% w/w to about 0.4% w/w based on the total weight of the tablet. The antifoaming agent may be present in an amount of less than about 2.0% w/w, less than about 1.5% w/w, less than about 1.0% w/w, less that about 0.8% w/w, less than about 0.7% w/w, less than about 0.6% w/w, less than about 0.5% w/w, or less that about 0.4% w/w. The antifoaming agent may be present in an amount of more than about 0.1% w/w, more than about 0.15% w/w, more than about 0.18% w/w, more that about 0.2% w/w, or more than about 0.25% w/w.

In some embodiments, the antifoaming agent is present in a powder containing the plant nutrient composition disclosed herein. For example, the polyethylene glycol filler may be present in the powder in an amount of about 0.1% w/w to about 2.0% w/w based on the total weight of the powder. The antifoaming agent may be present in an amount of about 0.2% w/w to about 1.5% w/w based on the total weight of the powder. The antifoaming agent may be present in an amount of about 0.3% w/w to about 1.0% w/w based on the total weight of the powder. The antifoaming agent may be present in an amount of about 0.4% w/w to about 0.9% w/w based on the total weight of the powder. The antifoaming agent may be present in an amount of about 0.6% w/w to about 0.8% w/w based on the total weight of the powder. The antifoaming agent may be present in an amount of less than about 2.0% w/w, less than about 1.5% w/w, less than about 1.2% w/w, less that about 1.0% w/w, less than about 0.9% w/w, or less than about 0.8% w/w. The antifoaming agent may be present in an amount of more than about 0.1% w/w, more than about 0.2% w/w, more than about 0.3% w/w, more that about 0.4% w/w, more than about 0.5% w/w, or more than 0.6%.

In other embodiments, the antifoaming agent may be present in an amount between any two of the previous upper and/or lower ranges as described above.

### Antimicrobial Agent

In some embodiments, the plant nutrient composition disclosed herein comprise an antimicrobial agent. The antimicrobial agent may be in powder or liquid form. In an example, the antimicrobial agent is in powder form. The antimicrobial agent may be a bacterial extract or synthetic antimicrobial, for example to reduce or stop microbial growth of a plant nutrient solution. In an example the antimicrobial agent may be selected from the group consisting of artemisia anua extract, essential oil, silver chloride, potassium sorbate, phloxine b, prodigiosin, violacein, oocydin A, citric acid, benzoic acid, sorbic acid, legulinic acid, boric acid, calcium propionate powder (2598), lavorIn® JP (world technology ingredients), DV™ (world technology ingredients), MARINAL® Protek (world technology ingredients), Mirenat®—D, Mirenat®—NS, Mirenat®—NSM, NATAMYCIN, or any combinations thereof.

In some embodiments, the antimicrobial agent is present in a powder containing the plant nutrient composition disclosed herein. In some embodiments, the antimicrobial agent is present in a tablet containing the plant nutrient composition disclosed herein. For example, the amount of antimicrobial agent present in the powder or the tablet containing the plant nutrient composition disclosed herein may be about 0.05% w/w to about 0.5% w/w based on the total weight of the powder or tablet. The antimicrobial agent may be present in an amount of about 0.06% w/w to about 0.4% w/w. The antimicrobial agent may be present in an amount of about 0.07% w/w to about 0.3% w/w. The antimicrobial agent may be present in an amount of about 0.08% w/w to about 0.2% w/w. The antimicrobial agent may be present in an amount of about 0.09% w/w to about 0.1% w/w. The antimicrobial agent may be present in an amount of less than about 0.5% w/w, less than about 0.4% w/w, less than 0.3% w/w, or less than about 0.2% w/w, or less than about 0.1% w/w. The antimicrobial agent may be present in an amount of more than about 0.05% w/w, less than about 0.06% w/w, less than 0.07% w/w, or less than about 0.08% w/w, or more than about 0.09 w/w.

In other embodiments, the antimicrobial agent may be present in an amount between any two of the previous upper and/or lower ranges as described above.

### Colouring Agent

In some embodiments, the plant nutrient composition disclosed herein comprise a colorant. The colorant may be a dye or pigment, for example to provide colouration or for distinguishing from other plant nutrient compositions disclosed herein. The colorant may be an antimicrobial colorant, for example for utilizing the additional functionality of an antimicrobial agent. In an example, the colouring agent may be selected from the group consisting of phloxine b, prodigiosin, violacein, ponceau red (CAS: 2611-82-7), brown LLB powder colour (CAS: 4553-89-3, 53026-69-9), brilliant blue (CAS: 3844-45-9), brilliant green, chlorophyll, spirulina, pure tintex food grade dye, phylam food grade powdered dyes e.g. annatto powder, chromatech food grade powdered dyes e.g. C71000 Powder/C71003 Granular, Cathay Industries EXACERT food grade water soluble dyes e.g. D&C Red No. 33, or any combinations thereof.

In some embodiments, the colouring agent is present in a powder containing the plant nutrient composition disclosed herein. In some embodiments, the colouring agent is present in a tablet containing the plant nutrient composition disclosed herein. For example, the amount of colouring agent present in the powder or the tablet containing the plant nutrient composition disclosed herein may be about 0.05% w/w to about 0.5% w/w based on the total weight of the powder or tablet. The colouring agent may be present in an amount of about 0.06% w/w to about 0.4% w/w. The colouring agent may be present in an amount of about 0.07% w/w to about 0.3% w/w. The colouring agent may be present in an amount of about 0.08% w/w to about 0.2% w/w. The colouring agent may be present in an amount of about 0.09% w/w to about 0.1% w/w. The colouring agent may be present in an amount of less than about 0.5% w/w, less than about 0.4% w/w, less than 0.3% w/w, or less than about 0.2% w/w, or less than about 0.1% w/w. The colouring agent may be present in an amount of more than about 0.05% w/w, less than about 0.06% w/w, less than 0.07% w/w, or less than about 0.08% w/w, or more than about 0.09 w/w.

In other embodiments, the colouring agent may be present in an amount between any two of the previous upper and/or lower ranges as described above.

### Effervescent Agent

In some embodiments, the plant nutrient composition disclosed herein comprises an effervescent agent. The effervescent agent can be provided for use in dissolution and dispersion of the plant nutrient composition in an aqueous liquid. In an embodiment, the effervescent agent is present in a tablet containing the plant nutrient composition disclosed herein. The effervescent agent present in the tablet may comprise a carbon dioxide agent, and optionally an acid agent. The effervescent agent together with the polyethylene glycol filler may advantageously facilitate dissolution and dispersion of the plant nutrient composition in an aqueous liquid or solution, for example the dissolution and dispersion may occurs rapidly such as to prevent or reduce the formation of highly concentrated pockets of the plant nutrient source. The presence and duration of highly concentrated pockets of plant nutrients can reduce dissolution of those nutrients in the aqueous liquid or solution.

In some embodiments. the carbon dioxide agent may comprise potassium carbonate, potassium bicarbonate, sodium carbonate, sodium bicarbonate, calcium carbonate, calcium bicarbonate, iron carbonate, ammonium carbonate, ammonium bicarbonate, lithium carbonate, magnesium carbonate, magnesium bicarbonate, or any combinations thereof. In an example, the carbon dioxide agent may be selected from at least one of potassium carbonate and potassium bicarbonate. In another example, the carbon dioxide agent may be potassium carbonate. In yet another example, the carbon dioxide agent may be potassium bicarbonate.

In some embodiments, the carbon dioxide agent is present in an amount of about 5% w/w to about 50% w/w based on the total weight of the tablet. The carbon dioxide agent may be present in an amount of about 10% w/w to about 45% w/w based on the total weight of the tablet. The carbon dioxide agent may be present in an amount of about 20% w/w to about 40% w/w based on the total weight of the tablet. The carbon dioxide agent may be present in an amount of about 25% w/w to about 35% w/w based on the total weight of the tablet. The carbon dioxide agent may be present in an amount of less than about 50% w/w, less than about 48% w/w, less than about 45% w/w, less than about 42% w/w, less than about 40% w/w, less than about 38% w/w, or less than about 35% w/w. The carbon dioxide agent may be present in an amount of more than about 5% w/w, more than about 10% w/w, more than about 12% w/w, more than about 15% w/w, more than about 18% w/w, more than about 20% w/w, or more than about 25% w/w.

In other embodiments, the carbon dioxide agent may be present in an amount between any two of the previous upper and/or lower ranges as described above.

In some embodiments, the acid agent may comprise formic acid, acetic acid, propionic acid, butyric acid, valeric acid, caproic acid, oxalic acid, lactic acid, malic acid, citric acid, benzoic acid, carbonic acid, uric acid, fulvic acid, humic acid, EDTA, HEDTA, DTPA, EDDHA, NTA, hydrochloric acid, nitric acid, sulfuric acid, boric acid, hydrofluoric acid, perchloric acid. In an example, the acid agent may be citric acid. In another example, the acid agent may be humic acid. In yet another example, the acid agent may be fulvic acid. In a further example, the acid agent may be citric acid in combination with any one or more acid agents described herein.

In some embodiments, the acid agent may be present in an amount of about 10 to 50% w/w based on the total weight of the tablet. The acid agent may be present in an amount of about 10% w/w to about 45% w/w based on the total weight of tablet. The acid agent may be present in an amount of about 15% w/w to about 40% w/w based on the total weight of the tablet. The acid agent may be present in an amount of about 20% w/w to about 35% w/w based on the total weight of the tablet. The acid agent may be present in an amount of about 25% w/w to about 30% w/w based on the total weight of the tablet. The acid agent may be present in an amount of less than about 50% w/w, less than about 48% w/w, less than about 45% w/w, less than about 42% w/w, less than about 40% w/w, less than about 38% w/w, less than about 35% w/w, less than 32% w/w, less than 30% w/w, or less than 28% w/w. The acid agent may be present in an amount of more than about 10% w/w, more than about 12% w/w, more than about 14% w/w, more than about 16% w/w, more than about 18% w/w, more than about 20% w/w, more than 22% w/w, or more than about 25% w/w.

In other embodiments, the acid agent may be present in an amount between any two of the previous upper and/or lower ranges as described above.

### Polyethylene Glycol Filler:Effervescent Agent

In some embodiments, the ratio of polyethylene glycol filler:effervescent agent may vary. The ratio of polyethylene glycol filler:effervescent agent may advantageously facilitate fast dissolution and dispersion of the plant nutrient composition in an aqueous solution such that the fast dissolution and dispersion prevents the formation of highly concentrated pockets of the plant nutrient.

In some embodiments, the ratio of polyethylene glycol filler:effervescent agent may be 0.03:1, 0.04:1, 0.05:1, 0.06:1, 0.07:1, 0.08:1, 0.09:1, 0.1:1, 0.11:1, 0.12:1, 0.13:1, 0.14:1, 0.15:1, 0.16:1, 0.17:1, 0.18:1, 0.19:1, 0.2:1, 0.25:1, 0.3:1, 0.35:1, 0.4:1, 0.45:1, or 0.5:1. The ratio of polyethylene glycol filler:effervescent agent may be in a range of about 0.05:1 to about 0.4:1. The ratio of polyethylene glycol filler:effervescent agent may be in a range of about 0.1:1 to about 0.2:1. The ratio of polyethylene glycol filler:effervescent agent may be less than 0.4:1, less than 0.35:1, less than 0.3:1, less than 0.25:1, or less than 0.2:1. The ratio of polyethylene glycol filler:effervescent agent may be more than 0.9:1, more than 0.1:1, more than 0.11:1, more than 0.12:1, more than 0.13:1, more than 0.14:1 or more than 0.15:1.

In other embodiments, the ratio of polyethylene glycol filler:effervescent agent may be between any two of the previous upper and/or lower ranges as described above.

### Powder Containing Plant Nutrient Composition

In an embodiment, there is provided a powder containing a plant nutrient composition as described herein. In an embodiment, the powder may comprise the plant nutrient source, the polyethylene glycol filler, and optionally one or more additives. The additive may be selected from at least one of an antifoaming agent and/or an antimicrobial agent, according to any embodiments or examples as described herein.

In an embodiment, the powder containing a plant nutrient composition as described herein consists of the plant nutrient source, polyethylene glycol filler, optionally one or more additives as described herein. The one or more additives may be selected according to any embodiments or examples as described herein. For example, the one or more additives may be selected from the group consisting of an antifoaming agent, antimicrobial agent, colouring agent, effervescent agent, plant growth regulator, biostimulant, phytohormones, and any combinations thereof. The additive may be selected from at least one of an antifoaming agent and/or an antimicrobial agent, according to any embodiments or examples as described herein.

In another embodiment, the powder containing a plant nutrient composition as described herein consists of between about 65% w/w to about 90% w/w of the plant nutrient source, between about 6% w/w to about 30% w/w of the polyethylene glycol filler, between about 0.1% w/w to about 2.0% w/w of the antifoaming agent, and between about 0.05% w/w to about 0.5% w/w of the antimicrobial agent.

In a more preferred embodiment, the powder containing a plant nutrient composition as described herein consists of about 78% w/w of the plant nutrient source, about 20% w/w of the polyethylene glycol filler, about 0.7% w/w of the antifoaming agent, and about 0.09% w/w of the antimicrobial agent.

### Tablet Containing Plant Nutrient Composition

In an embodiment, there is provided a tablet containing a plant nutrient composition as described herein. In an embodiment, the tablet may comprise the plant nutrient source, the polyethylene glycol filler, and optionally one or more additives as described herein. The additive may be selected from at least one of an effervescent agent, antifoaming agent and/or an antimicrobial agent, according to any embodiments or examples as described herein.

In an embodiment, the tablet containing a plant composition as described herein consists of the plant nutrient source, the polyethylene glycol filler, the acid agent, the carbon dioxide agent, and optionally one or more additives as described herein. The one or more additives may be selected according to any embodiments or examples as described herein. For example, the one or more additives may be selected from the group consisting of an antifoaming agent, antimicrobial agent, colouring agent, effervescent agent, plant growth regulator, biostimulant, phytohormones, and any combinations thereof. The additive may be selected from at least one of an antifoaming agent and/or an antimicrobial agent, according to any embodiments or examples as described herein.

In another embodiment, the tablet containing a plant composition as described herein consists of between about 20% w/w to about 50% w/w of the plant nutrient source, between about 6% w/w to about 30% w/w of the polyethylene glycol filler, between about 20% w/w to about 35% w/w of the acid agent, between about 25% w/w to about 35% w/w of the carbon dioxide agent, between about 0.1% w/w to about 2.0% w/w of the antifoaming agent, and between about 0.05% w/w to about 0.5% w/w of the antimicrobial agent.

In a most preferred embodiment, the tablet containing a plant composition as described herein consists of about 34% w/w of the plant nutrient source, about 9% w/w of the polyethylene glycol filler, about 27% w/w of the acid agent, about 30% w/w of the carbon dioxide agent, about 0.3% w/w of the antifoaming agent, and about 0.09% w/w of the antimicrobial agent.

### Process for Preparing a Powder or Tablet

In some embodiments, a process for preparing a powder containing the plant nutrient composition as described herein can comprise combining a plant nutrient source, a polyethylene glycol filler, and optionally one or more additives as described herein. For example, the process for preparing the powder containing a plant nutrient composition as described herein comprises combining between about 65% w/w to about 90% w/w of the plant nutrient source, between about 6% w/w to about 30% w/w of the polyethylene glycol filler, between about 0.1% w/w to about 2.0% w/w of the antifoaming agent, and between about 0.05% w/w to about 0.5% w/w of the antimicrobial agent. In another example, the process for preparing the powder containing a plant nutrient composition as described herein comprises combining about 78% w/w of the plant nutrient source, about 20% w/w of the polyethylene glycol filler, about 0.7% w/w of the antifoaming agent, and about 0.09% w/w of the antimicrobial agent.

In some embodiments, a process for preparing a tablet containing the plant nutrient composition as described herein can comprise combining a plant nutrient source, a polyethylene glycol filler, optionally an acid agent, a carbon dioxide agent, and optionally one or more additives as described herein. For example, the process for preparing the tablet containing a plant nutrient composition as described herein comprises combining between about 20% w/w to about 50% w/w of the plant nutrient source, between about 6% w/w to about 30% w/w of the polyethylene glycol filler, between about 20% w/w to about 35% w/w of the acid agent, between about 25% w/w to about 35% w/w of the carbon dioxide agent, between about 0.1% w/w to about 2.0% w/w of the antifoaming agent, and between about 0.05% w/w to about 0.5% w/w of the antimicrobial agent. In another example, the process for preparing the tablet containing a plant nutrient composition as describe herein comprises combining about 34% w/w of the plant nutrient source, about 9% w/w of the polyethylene glycol filler, about 27% w/w of the acid agent, about 30% w/w of the carbon dioxide agent, about 0.3% w/w of the antifoaming agent, and about 0.09% w/w of the antimicrobial agent.

The process may comprise any one or more of the embodiments or examples as described herein in relation to the powder or tablet containing the plant nutrient composition.

### Method for Using a Powder or Tablet

A method of preparing a plant nutrient solution can comprise introducing a plant nutrient composition as described herein into an aqueous solution. The plant nutrient composition may be introduced into the aqueous solution as a single dose to provide all essential nutrients to the plant for a predetermined time. The predetermined time may be about 1 day, 1 week, 2 weeks, 1 month, 2 months or every three months. The plant nutrient composition may be provided in the form of a powder containing the plant nutrient composition as described herein. The plant nutrient composition may be provided in the form of a tablet containing the plant nutrient composition as described herein.

In some embodiments, the method of preparing the plant nutrient solution may comprise introducing a powder containing the plant nutrient composition into an aqueous solution such that the powder may be further agitated. The powder may be further agitated by means of a device or a mechanical mechanism to put something into motion by shaking or stirring. It will be understood that a device or a mechanical mechanism can include any means to shake or stir a solution. For example, the device or mechanical mechanism can include any means which allows rotation back and forth or contains a magnetic bar rotating in a magnetic field. It will also be understood that a device or mechanical mechanism can come in many sizes and varieties depending on the weight of the powder containing the plant nutrient composition and/or the volume of aqueous solution.

In some embodiments, the method of preparing the plant nutrient solution may comprise introducing a tablet containing the plant nutrient composition into an aqueous solution such that the tablet may be introduced without any agitation of the aqueous solution.

In some embodiments, the amount of plant nutrient source per dose is in the range of about 25 w/w to about 85% w/w of the powder or tablet. In some embodiments, the plant nutrient source is present in a tablet containing the plant nutrient composition disclosed herein. For example, the plant nutrient source may be present in the tablet in an amount of about 20% w/w to about 50% w/w based on the total weight of the plant nutrient composition. The plant nutrient source may be present in an amount of about 25% w/w to about 45% w/w based on the total weight of the plant nutrient composition. The plant nutrient source may be present in an amount of about 30% w/w to about 40% w/w based on the total weight of the plant nutrient composition. The plant nutrient source may be present in an amount of about 32% w/w to about 38% w/w based on the total weight of the plant nutrient composition. The plant nutrient source may be present in an amount of less than about 50% w/w, less than about 48% w/w, less than about 45% w/w, less that about 42% w/w, less than about 40% w/w, or less than about 38% w/w. The plant nutrient source may be present in an amount of more than about 20% w/w, more than about 22% w/w, more than about 25% w/w, more that about 28% w/w, more than about 30% w/w, or more than about 32% w/w. In some embodiments, the plant nutrient source is present in a powder containing the plant nutrient composition disclosed herein. For example, the plant nutrient source may be present in the powder in an amount of about 65% w/w to about 90% w/w based on the total weight of the plant nutrient composition. The plant nutrient source may be present in an amount of about 68% w/w to about 88% w/w based on the total weight of the plant nutrient composition. The plant nutrient source may be present in an amount of about 70% w/w to about 85% w/w based on the total weight of the plant nutrient composition. The plant nutrient source may be present in an amount of about 72% w/w to about 82% w/w based on the total weight of the plant nutrient composition. The plant nutrient source may be present in an amount of about 74% w/w to about 80% w/w based on the total weight of the plant nutrient composition. The plant nutrient source may be present in an amount of less than about 90% w/w, less than about 88% w/w, less than about 85% w/w, less that about 82% w/w, or less than about 80% w/w. The plant nutrient source may be present in an amount of more than about 65% w/w, more than about 68% w/w, more than about 70% w/w, more that about 72% w/w, or more than about 74% w/w.

In other embodiments, the plant nutrient source may be present in an amount between any two of the previous upper and/or lower ranges as described above.

It will be appreciated that the weight of the tablet or powder containing the plant nutrient composition can vary depending on several factors. For example, the size of the crop, the size of the hydroponic system, the type of plant or crop, and stage in the plant life cycle. In some embodiments, the powder or tablet may be provided at a weight of about 0.5 g to about 3.6 kg per dose. In other embodiments, the powder or tablet may be provided at a weight of about 1.5 g to about 360 g. In a most preferred embodiment, the powder or tablet may be provided at a weight of about 3.5 g to about 70 g.

It will also be appreciated that the volume of aqueous solution required for a tablet or powder containing the plant nutrient composition can vary depending on the weight of the tablet or powder. In some embodiments, the volume of aqueous solution may be about 0.5 L to about 1000 L per dose of a tablet or powder containing the plant nutrient composition described herein. In other embodiments, the volume of aqueous solution may be about 0.2 L to about 100 L per dose of a tablet or powder containing the plant nutrient composition described herein. In a most preferred embodiment he volume of aqueous solution may be about 1 L to about 20 L per dose of a tablet or powder containing the plant nutrient composition described herein.

In some embodiments, the electrical conductivity of the plant nutrient solution prepared from a tablet or powder containing the plant nutrient composition may be from about 0.5 dS m⁻¹ to about 3 dS m⁻¹. In other embodiments, the electrical conductivity of the plant nutrient solution prepared from a tablet or powder containing the plant nutrient composition may be from about 0.8 dS to about 1.2 dS

In some embodiments, the pH of the plant nutrient solution prepared from a tablet or powder containing the plant nutrient composition may be between about 5.5 to about 6.5. For example, the pH of the plant nutrient solution may be between about 5.8 to about 6.0.

Many modifications of examples set forth herein will come to mind to one skilled in the art to which the present disclosure pertains having the benefit of the teachings presented in the foregoing descriptions and the associated drawings and figures. Therefore, it is to be understood that the present disclosure is not to be limited to the specific examples illustrated and that modifications and other examples are intended to be included within the scope of the appended claims. Moreover, although the foregoing description and the associated drawings and figures describe examples of the present disclosure in the context of certain illustrative combinations of elements and/or functions, it should be appreciated that different combinations of elements and/or functions may be provided by alternative implementations without departing from the scope of the appended claims.

### EXAMPLES

The present disclosure will now be described with reference to the following non-limiting examples and with reference to the accompanying figures.

### Materials and Methods

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

### Example 1: Variation on Type of Filler

Research was undertaken to determine an effective filler that does not provide an effective substrate for microbes and is stable as a filler and/or binder. A sample of sewage sludge was analysed whereby several chemical agents were identified as potentially effective fillers having properties described above. Several of the agents identified from the sewage sludge were tested for their effectiveness as a filler. The experimental data for three of the agents are presented below:

### List of Fillers Tested

Artemisia Anua Extract
Phytosterol
PEG 3350

### General Procedure for Testing Varying Fillers

A tablet containing plant nutrient composition was prepared by combining a plant nutrient source, a filler, and 2:1 ratio of effervescent agent (potassium carbonate:citric acid). A small amount (10 μL) of water was added to each composition, then stirred. Each mixture was cooled for approx. 30 minutes at 4° C., then diluted in 400 mL of water using an ‘air-stone’.

### Observations

### Composition 1—Artemisia Anua Extract Filler

It was observed that composition 1 did not bind together in a way that could produce a commercially viable tablet. In other words, the Artemisia Anua extract was shown not perform effectively as a filler that could also function as a suitable binder for preparing a tablet.

### Composition 2—Phytosterol Filler

It was observed that composition 2 also did not form a single solid tablet. The composition had no cohesion and remained as a loose powder. In other words, the phytosterol was shown not perform effectively as a filler that could also function as a suitable binder for preparing a tablet.

### Composition 3—PEG 3350 Filler

It was observed that composition 3 formed compacted solid that had cohesion. In other words, the PEG filler was surprisingly shown to perform effectively as a filler that could also function as a suitable binder for preparing a tablet.

### Conclusion

From the observations described above, composition 3 unexpectedly achieved effective binding to produce a solid mass that was then surprisingly shown to provide a fast dissolution and dispersion of the plant nutrient source into an aqueous solution.

### Example 2: PEG 3350 Filler, Effervescent Agent and Nutrient Salt in a Tablet

The ratios of PEG 3350, effervescent agent and plant nutrient salt were further investigated.

### Preparation of Tablet

An amount of plant nutrient source was combined with varying amounts of PEG 3350 and 2:1 (potassium bicarbonate:citric acid) ratio of effervescent agent. The plant nutrient source, PEG and effervescent agent were combined, transferred to a mortar and homogenised by grinding with a pestle. The mixture was then ‘tamped’ down to form tablets and refrigerated for 30 minutes. The tablets were then dissolved in 800 mL water with an ‘airstone’.

### Observations

Composition 4 (20% w/w PEG)

0.5 g PEG+1.5 g effervescent agent+0.5 g plant nutrient source

Composition 4 could be very effectively compressed into a solid tablet that dissolved moderately well and with a moderate amount fizzing. A small amount of foam was present that dissipated quickly. A small amount of sediment was still present after 2 minutes.

Composition 5 (12.5% w/w PEG)

0.5 g PEG+3 g effervescent agent+0.5 g plant nutrient source

Composition 5 could be effectively compressed into a solid tablet and showed slightly more aggressive dissolution and fizzing. Composition 5 dissolved faster than composition 4 and with less sediment present. Composition 5 was observed to have slightly more foaming than composition 4 and a clear solution was achieved after approx. 1 minute.

Composition 6 (11% w/w PEG)

0.25 g PEG+1.5 g effervescent agent+0.5 g plant nutrient source

Composition 6 could be effectively compressed into a solid tablet that dissolved very quickly with fizzing. There was a small amount of non-dissolved matter floating and sediment present in the resulting plant nutrient solution after 2 minutes and slightly more foaming was observed as compared to composition 4.

Composition 7 (8% w/w PEG)

0.5 g PEG+6 g effervescent agent+0.5 g plant nutrient source

Composition 7 could be compressed into a solid tablet and showed more aggressive fizzing than that of composition 6. A clear plant nutrient solution was achieved after approx. 1.5 minutes. The resulting plant nutrient solution appeared similar to that of composition 6.

Composition 8 (6% w/w)

0.125 g PEG+1.5 g effervescent agent+0.5 g plant nutrient source

Composition 8 could be compressed into a solid but less effectively, although dissolved very quickly with fizzing. There was more foaming observed than for composition 7.

### Conclusions

Overall, compositions 5 and 6 provided the best results. The compositions were able to be effectively compressed into a solid composition and appeared to dissolve quickly with aggressive fizzing to achieve clear plant nutrient solutions in less than 2 minutes.

### Example 3: Effervesce Agent and PEG Filler

Based on observations that higher amounts of PEG reduces dissolving time and the higher amounts of effervescent agent increases dissolving time (and foaming), an investigation was conducted to determine an advantageous ratio of PEG filler:effervescent agent.

### Preparation of Tablet

An amount of plant nutrient source was combined with varying amounts of PEG 3350 and effervescent agent. The plant nutrient source, PEG and effervescent agent were combined, transferred to a mortar and homogenised by grinding with a pestle. The mixture was then ‘tamped’ down to form tablets and refrigerated for 30 minutes. The tablets were then dissolved in 800 mL water with an ‘airstone’.

### Observations

Composition 9 (11% w/w PEG, Ratio PEG:EA 0.25:1)

0.25 g PEG+1 g effervescent agent+1 g plant nutrient source

Composition 9 was slower to dissolve and disperse. Some foaming present. The resulting plant nutrient solution completely dissolved after 4 minutes and had a pH of 6.3.

Composition 10 (9% w/w PEG, Ratio PEG:EA 0.17:1)

0.25 g PEG+1.5 g effervescent agent+1 g plant nutrient source

Composition 10 dissolved and dispersed very quickly with fizzing. Some foaming present. The resulting plant nutrient solution completely dissolved after approx. 40 seconds and had a pH of 6.6.

Further advantages, such as obtaining a desired pH, were identified where citric acid is provided in an amount of up to 0.25 g.

Composition 11 (8% w/w PEG, Ratio PEG:EA 0.13:1),

0.25 g PEG+2 g effervescent agent+1 g plant nutrient source

Composition 11 dissolved quickly with aggressive fizzing and dispersion. Some foaming present, less than composition 9. The resulting plant nutrient solution completely dissolved after approx. 1 minute 15 seconds and had a pH of 6.4.

Composition 12 (6% w/w PEG, Ratio PEG:EA 0.09:1)

0.25 g PEG+3 g effervescent agent+1 g plant nutrient source

Composition 12 quickly dissolved and dispersed. Some foaming present, less than composition 9. The resulting plant nutrient solution completely dissolved after approx. 1 minute and had a pH of 6.6.

### Conclusions

Overall, composition 10 provided the best results. The composition appeared to dissolve and disperse quickly with aggressive fizzing to achieve clear plant nutrient solutions in in approx. 40 seconds.

1. A solution dispersible plant nutrient composition comprising:
a plant nutrient source comprising nitrogen, phosphorus and potassium, for providing nutrients to a plant;
a polyethylene glycol filler in an amount of about 6% w/w to about 30% w/w for facilitating dispersion and dissolution of the plant nutrient source into an aqueous solution; and
an effervescent agent.

2. The plant nutrient composition of claim 1, wherein the polyethylene glycol is selected from the group consisting of polyethylene glycol 200, polyethylene glycol 300, polyethylene glycol 400, polyethylene glycol 540, polyethylene glycol 600, polyethylene glycol 1000, polyethylene glycol 1450, polyethylene glycol 3350, polyethylene glycol 4000, polyethylene glycol 4600, polyethylene glycol 8000, and combinations thereof.

3. The plant nutrient composition of claim 2, wherein the polyethylene glycol is selected from polyethylene 3350.

4. The plant nutrient composition of any one of the preceding claims, wherein the plant nutrient source further comprises chelated micronutrients.

5. The plant nutrient composition of claim 4, wherein the chelating agent for the chelated micronutrients is selected from the group consisting of organic acids and inorganic acids.

6. The plant nutrient composition of any one of the preceding claims, wherein the composition further comprises an antifoaming agent.

7. The plant nutrient composition of any one of the preceding claims, wherein the composition further comprises an antimicrobial agent.

8. The plant nutrient composition any one of the preceding claims, wherein the effervescent agent comprises a carbon dioxide agent, and optionally an acid agent.

9. The plant nutrient composition of claim 8, wherein the carbon dioxide agent comprises potassium carbonate, potassium bicarbonate, sodium carbonate, sodium bicarbonate, calcium carbonate, calcium bicarbonate, iron carbonate, ammonium carbonate, ammonium bicarbonate, lithium carbonate, magnesium carbonate, magnesium bicarbonate, or any combinations thereof.

10. The plant nutrient composition of claim 9, wherein the carbon dioxide agent is selected from at least one of potassium carbonate and potassium bicarbonate.

11. The plant nutrient composition of claim 8 to claim 10, wherein the carbon dioxide agent is present in an amount of about 5 to 50% w/w, preferably about 25% w/w to about 35% w/w.

12. The plant nutrient composition of claim 8, wherein the acid agent comprises an organic acid, inorganic acid, or any combinations thereof.

13. The plant nutrient composition of claim 12, wherein the acid agent is formic acid, acetic acid, propionic acid, butyric acid, valeric acid, caproic acid, oxalic acid, lactic acid, malic acid, citric acid, benzoic acid, carbonic acid, uric acid, fulvic acid, humic acid, EDTA, HEDTA, DTPA, EDDHA, NTA, hydrochloric acid, nitric acid, sulfuric acid, boric acid, hydrofluoric acid, perchloric acid.

14. The plant nutrient composition of claim 12 or claim 13, wherein the acid agent is present in an amount of about 10 to 50% w/w, preferably about 20% w/w to about 35% w/w.

15. The plant nutrient composition of any one of claims 8 to 14, wherein the ratio of acid agent to carbon dioxide agent for the effervescent agent is provided in a range of about 1:3 to 3:1, preferably about 1:1.

16. The plant nutrient composition of any one of the preceding claims, wherein the plant nutrient source comprises macronutrients selected from at least one of nitrogen, phosphorus and potassium, wherein the content of nitrogen is present in an amount of about 0% to about 10% nitrogen, the content of phosphorous is present in an amount of about 0% to about 10%, and the content of potassium is present in an amount of about 0% to about 10%.

17. The plant nutrient composition of any one of the preceding claims, wherein the composition further comprises one or more additional excipients selected from plant growth regulators, biostimulants, and phytohormones

18. The plant nutrient composition of any one of the preceding claims, wherein the composition further comprises a colouring agent.

19. The plant nutrient composition of claim 18, wherein the colouring agent is an antimicrobial colouring agent.

20. A tablet containing the composition of any one of claims 1 to 19.

21. The tablet of claim 21, wherein the tablet is provided at a weight of about 0.5 g to about 3.6 kg per tablet, preferably about 3 g to about 360 g.

22. The tablet of claim 20 or claim 21, wherein the composition consists of:
the plant nutrient source;
the polyethylene glycol filler;
the acid agent;
the carbon dioxide agent;
optionally the antifoaming agent; and
optionally the antimicrobial agent.

23. The tablet of any one of claims 20 to 22, wherein the composition consists of:
between about 20% w/w to about 50% w/w of the plant nutrient source;
between about 6% w/w to about 30% w/w of the polyethylene glycol filler;
between about 20% w/w to about 35% w/w of the acid agent;
between about 25% w/w to about 35% w/w of the carbon dioxide agent;
between about 0.1% w/w to about 2.0% w/w of the antifoaming agent; and
between about 0.05% w/w to about 0.5% w/w of the antimicrobial agent.

24. The tablet of any one of claims 20 to 23, wherein the composition consists of:
about 34% w/w of the plant nutrient source;
about 9% w/w of the polyethylene glycol filler;
about 27% w/w of the acid agent;
about 30% w/w of the carbon dioxide agent;
about 0.3% w/w of the antifoaming agent; and
about 0.09% w/w of the antimicrobial agent

25. A powder containing the composition of any one of claims 1 to 19.

26. The powder of claim 25, wherein the composition consists of:
the plant nutrient source;
the polyethylene glycol filler;
optionally the antifoaming agent; and
optionally the antimicrobial agent.

27. The powder of claim 25 or claim 26, wherein the composition consists of:
between about 65% w/w to about 90% w/w of the plant nutrient source;
between about 6% w/w to about 30% w/w of the polyethylene glycol filler;
between about 0.1% w/w to about 2.0% w/w of the antifoaming agent; and
between about 0.05% w/w to about 0.5% w/w of the antimicrobial agent.

28. The powder of any one of claims 25 to 27, wherein the composition consists of:
about 78% w/w of the plant nutrient source;
about 20% w/w of the polyethylene glycol filler;
about 0.7% w/w of the antifoaming agent; and
about 0.09% w/w of the antimicrobial agent.

29. A method of preparing a plant nutrient solution by introducing a plant nutrient composition of any one of claims 1 to 19 in an aqueous solution.

30. The method of claim 29, wherein the plant nutrient composition is introduced into the aqueous solution as a single dose to provide one or more nutrients, base nutrients, nutrient supplements, or any combination thereof to the plant for a predetermined time.

31. The method of claim 19, wherein the predetermined time is about 1 day, 1 week, 2 weeks, 1 month, 2 months or every three months.

32. The method of any one of claims 29 to 31, wherein the plant nutrient composition is provided in the form of the powder or tablet.

33. The method of claim 32, wherein the powder is further agitated.

34. The method of claim 32, wherein the tablet is introduced without any agitation of the aqueous solution.

35. The method of any one of claims 32 to 34, wherein the amount of plant nutrient source per dose is in the range of about 25% w/w to about 85% w/w of the powder or tablet.

36. The method of any one of claims 32 to 35, wherein the powder or tablet is provided at a weight of about 0.5 g to about 3.6 kg per dose, preferably about 1.5 g to about 360 g, even more preferably about 3.5 g to about 70 g.

37. The method of claim 36, wherein the volume of aqueous solution is about 0.5 L to about 1000 L per dose of plant nutrient composition, preferably about 0.2 L to about 100 L, even more preferably about 1 L to about 20 L.

38. The method of any one of claims 29 to 37, wherein the electrical conductivity of the plant nutrient solution is from about 0.5 dS m⁻¹ to about 3 dS m⁻¹, preferably about 0.8 dS m⁻¹ to about 1.2 dS m⁻¹.

39. The method of any one of claims 29 to 38, wherein the pH of the plant nutrient solution is between about 5.5 to about 6.5.

40. The method of claim 39, wherein the pH is between about 5.8 to about 6.0.

41. A process for preparing a plant nutrient composition comprising combining a plant nutrient source, a polyethylene glycol filler, and optionally one or more additional excipients, according to any one of claims 1 to 19.
